(19) United States
(12) Patent Application Publication
(10) Pub. No.: US 2012/0324010 A1
(43) Pub. Date: Dec. 20, 2012

(54) Social Networking System and Method

(76) Inventor: Brendan James Pinches, Templestowe (AU)

(21) Appl. No.: 13/582,854

(22) PCT Filed: Mar. 7, 2011
(86) PCT No.: PCT/AU2011/000251

§ 371 Date: Sep. 5, 2012

(30) Foreign Application Priority Data
Mar. 9, 2010 (AU) 2010900972

(51) Int. Cl. G06F 15/16

(52) U.S. Cl. 709/204

(57) ABSTRACT

A social networking system for a sporting competition comprising a server (10) configured to operate the system, a database (22) associated with the server for storing system data, and an interface through which registered users (12) access and interact with the system. The server (10) comprises a ratings module (20) configured to receive individual user ratings on one or more members of the sporting competition from one or more registered users and calculate a live average rating for one or more members of the sporting competition based on the individual user ratings.

### FIELD OF THE INVENTION

The present invention relates to a social networking system. In particular, although not exclusively, the social networking system is internet-based.

### BACKGROUND TO THE INVENTION

The internet is one of the main forums for the exchange of public opinion on various topics. For example, the public can express their views or opinions on a particular topic on blog websites or website polls. The fundamental problem with blogs and website polls is that often the identity of the users remain anonymous, which limits subsequent interaction by users and sharing of views. Social networking websites, such as Facebook and MySpace, address this problem to some extent in that users are required to register to access these websites and provide at least a basic level of personal information. The users can then connect or link to their friends, family, and other contacts via the social networking website and share information and their opinions on various topics to a select audience.

Sport, and more particularly the performance of sporting teams and players, generates wide debate and discussion worldwide. Often, such debate and the exchange of opinions on performance is played out at the sporting venues, living rooms, pubs, talkback radio, over the internet through media outlets, blogs and social networking websites. However, none of these outlets offers a forum for the wider public to express their views and opinions on sport with each other in a meaningful way.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide a social networking system and/or method for sporting competitions, or to at least provide the public with a useful choice.

### SUMMARY OF THE INVENTION

In a first aspect, the present invention broadly consists in a method of facilitating the rating of members of a sporting competition, comprising:
providing a social networking system having an interface that is accessible by a plurality of registered users;
receiving individual user ratings on one or more members of the sporting competition from one or more registered users via the interface; and
calculating a live average rating for one or more members of the sporting competition based on the individual user ratings.

Preferably, the step of providing a social networking system comprises providing server that is accessible via an interface over a network.

The network may be the internet, a cellular network, any other communications medium, whether wired or wireless, or any combination of these.

In one form, the interface may be a website interface that may be accessible by an internet browser program over the internet. By way of example, the website interface may be provided in the form of Graphical User Interfaces (GUIs) provided by web pages.

In another form, the interface may be in the form of a dedicated application program running on a programmable hardware device, including but not limited to a personal computer, whether a desktop, laptop, tablet, or notebook, a mobile phone or smart phone, a Personal Digital Assistant (PDA), or any other programmable device comprising a communications module for accessing a communications network to communicate with the server. By way of example, the application program interface may be provided in the form of interactive and navigatable GUIs.

Preferably, the step of receiving individual user ratings comprises receiving numerical ratings on a rating index. By way of example, the individual user ratings are based on the registered user's opinion of the performance of the member of the sporting competition.

Preferably, the step of receiving individual ratings comprises receiving ratings during rating periods associated with the timeline of the sporting competition. For example, in a multiple-round sporting competition comprising a series of rounds, individual user ratings may only be received during a specific rating period during each round. Alternatively, in a single-event sporting competition comprising a single match or game between two teams, the individual ratings may only be received during one or multiple rating periods during, before, and/or after the match or game. For example, a rating periods may be provided for each half or quarter of a match or the match may be segmented into ratings periods in other suitable ways appropriate to the type of game.

Preferably the step of calculating a live average rating comprises calculating a live average rating on one or more members of the sporting competition during each rating period, with the live average rating at the end of each rating period representing the final average rating for that member of the sporting competition for that rating period. In one form, the live average rating for a member is re-calculated each time a new individual user rating is received for that member or if an altered individual user rating is received. In another form, the live average rating for each member is re-calculated periodically.

Preferably, the method further comprises the step of calculating a competition average rating for one or more members of the sporting competition based on an average of the member's final average ratings for each rating period. For example, in a multi-round sporting competition comprising a series of rounds, each having a corresponding rating period, a competition average rating for each member is calculated based on the average of the final average ratings for the member from each rating period. Alternatively, in a single-event sporting competition comprising a single match or game between two teams, a competition average rating for each member is calculated based on the average of the final average ratings for the member from each rating period provided for the match. For example, the competition average rating may represent the member's average rating for the match for ratings provided by users for the first and second half of the match, or over four quarters of a match, depending on how the match is segmented into rating periods.

Preferably, the competition average rating is re-calculated at the end of each rating period.

Preferably, the method further comprises the step of receiving predicted ratings on one Or more members of the sporting competition from one or more registered users prior to the commencement of the sporting competition. More preferably, this step comprises only receiving predicted ratings during a predicted ratings period occurring prior to the commencement of the sporting competition. By way of example, the predicted ratings are based on the registered user's opinion of the likely performance of the member of the sporting competition before the commencement of the sporting competition, whether a multi-round sporting competition or single-event sporting competition.

Preferably, the method further comprises the step of storing all individual user ratings and logging those ratings against the registered users. The user ratings may also be time-stamped.

Preferably, the method further comprises the steps of receiving competition data relating to the sporting competition and configuring the social networking system in accordance with the competition data. Preferably, the competition data may comprise match data indicative of the match schedule or draw associated with a multi-round sporting competition, or alternatively match data indicative of the single match between two teams for a single-event sporting competition.

Preferably, the competition data may further comprise individual member data comprising information on each ratable member of the sporting competition. Each ratable member's individual member data may comprise one or more selected preset tag elements indicative of one or more characteristics of the ratable member. The individual member data may further comprise customised profile elements, each element containing other information about the ratable member as desired.

Preferably, the method further comprises the step of registering individual users to enable access to the social networking system. This step may further comprise receiving user account data for each individual user during registration. Preferably, the user account data may comprise one or more selected preset tag elements indicative of one or more characteristics of the user.

Preferably, the method further comprises calculating rankings for members of the sporting competition based on the individual user ratings received. More preferably, the step comprises calculating rankings for members of a ranking group, wherein the ranking group is defined by one or more selectable tag elements that are indicative of one or more common characteristics of the members of that group. Additionally, or alternatively, a ranking group may be defined to cover ratings entered by one or more registered users based on one or more associated tag elements common to the registered users.

Preferably, the method further comprises displaying the ratings on the interface of the social networking system. In one form, the ratings received are displayed on one or more webpages of a website interface. In another form, the ratings received are retrieved from the server and displayed by an application program interface using GUIs. More preferably, the ratings are displayed numerically, graphically, or in any other suitable form.

Preferably, the method further comprises the step of displaying the live average rating for one or more members of the sporting competition in a graphical form. More preferably, this step comprises generating and displaying a line-graph(s) of the live average rating(s) for one or more members of the sporting competition relative to time. In one form, this step comprises updating the line-graph representing the live average rating(s) of one or more members of the sporting competition periodically according to a predetermined time interval.

Preferably, the method further comprises sending or transmitting the ratings or ranking data, such as individual user ratings and/or live average rating for one or more members of the sporting competition, to an external system for processing, storage and/or display. In one form, the method further comprises the step of televising the live average rating of one or more members of the sporting competition, numerically, graphically or in any combination of these. By way of example, this step may comprise sending, either periodically, continually, or on request, the live average rating for one or more members of the sporting competition to an external system associated with a television broadcaster for subsequent broadcast to television viewers or alternatively directly televising the ratings and ranking data in any other manner. In another form, the method further comprises the step of displaying the ratings and/or ranking data on display screens located at the venue of a match being played in the sporting competition. The ratings and/or ranking data may be filtered such that only ratings and/or ranking data corresponding to members participating in the match at that venue are displayed.

In a second aspect, the present invention broadly consists in a social networking system for a sporting competition, comprising:
a server configured to operate the system;
a database associated with the server for storing system data;
an interface through which registered users may access and interact with the system, and the server comprising a ratings module configured to receive individual user ratings on one or more members of the sporting competition from one or more registered users and calculate a live average rating for one or more members of the sporting competition based on the individual user ratings.

Preferably, the system is implemented by computers and/or programmable electronic devices.

In one form, the interface may be a website interface that is accessible by registered users over a network, such as the internet, by using an internet browser on any suitable hardware device having network access, whether wired or wireless. More preferably, the website interface is provided in the form of GUIs provided on webpages hosted by the server.

In another form, the interface may be in the form of a dedicated application program running on a suitable programmable hardware device having network access, whether wired or wireless.

The network may be any communications medium, including the internet, a cellular network, or any other communications medium, whether wired or wireless, or any combination of these.

Preferably, the ratings module comprises a ratings interface through which registered users may interact to enter their individual ratings on one or more members of the sporting competition. More preferably, the ratings interface is configured to provide a selectable numerical rating on a rating index for the registered users.

Preferably, the ratings module is configured to receive ratings from individuals only during rating periods associated with the timeline of the sporting competition. For example, the ratings interface is operable during ratings periods, but inoperable or deactivated outside of rating periods.

Preferably, the ratings module is configured to calculate a live average rating for each member of the sporting competition during each rating period based on the collective ratings entered for each member by all registered users. More preferably, the live average rating at the end of each rating period is stored by the ratings module in the database as the final live average rating for that rating period. In one form, the ratings module is configured to re-calculate the live average rating got a member upon receiving a new individual user rating for that member or if an existing individual user rating is altered. In another form, the ratings module is configured to re-calculate the live average rating for each member periodically according to a preset time interval.

Preferably, the ratings module is configured to calculate a competition average rating for one or more members of the sporting competition based on an average of the member's final average ratings for each rating period. For example, in a multi-round sporting competition comprising a series of rounds, each having a corresponding rating period, the ratings module is configured to calculate a competition average rating for each member of the competition based on the average of the final average ratings for the members from each rating period. Alternatively, in a single-event sporting competition comprising a single match or game between two teams, a competition average rating for each member is calculated based on the average of the final average ratings for the member from each rating period provided for the match. For example, the competition average rating may represent the member's average rating for the match for ratings provided by users for the first and second half of the match, or over four quarters of a match, depending on how the match is segmented into rating periods.

Preferably, the ratings module is configured to re-calculate the competition average rating at the end of each rating period in the sporting competition.

Preferably, the ratings module comprises a predicated ratings system that is configured to receive predicted ratings on one or more members of the sporting competition from one or more registered users prior to the commencement of the sporting competition. More preferably, the predicted ratings system comprises a predicted rating interface through which registered users may interact to enter their individual predicted ratings on one or more members of the sporting competition based on the registered user's opinion of the likely performance of the member of the sporting competition before the commencement of the sporting competition, whether a multi-round sporting competition or single-event sporting competition. In one form, the predicted ratings interface is configured to provide a selectable numerical rating on a rating index for the registered users. The rating index for the predicted rating interface may have the same or a higher resolution than the corresponding rating index used during the sporting competition, but cover the same numerical range. Preferably, the predicted ratings system is only operable for receiving user ratings during a predetermined predicted ratings period occurring prior to the commencement of the sporting competition.

Preferably, the ratings module is configured to store all entered and calculated ratings into the database. The ratings may also be time-stamped and logged against the associated ratable member and registered user providing the rating.

Preferably, the server comprises a competition data module that is configured to receive competition data relating to the sporting competition. More preferably, the competition data module is arranged to configure the social networking system in accordance with the competition data received. The competition data may comprise of match data indicative of the match schedule or draw associated with the multi-round sporting competition, or alternatively match data indicative of the single match between two teams for a single-event sporting competition. The competition data may further comprise individual member data comprising information on each ratable member of the sporting competition. Each ratable member's individual member data may comprise one or more selected preset tag elements indicative of one or more characteristics of the ratable member. The individual member data may further comprise customised profile elements, each element containing other information about the ratable member as desired.

Preferably, server comprises a user account module having a user registration interface that is operable by new users to register as users for access to the social networking system. More preferably, the user account module is configured to receive user account data for each individual user during registration via the user registration interface. Preferably, the user account data may comprise one or more selected preset tag elements indicative of one or more characteristics of the user.

Preferably, the server comprises a rankings module that is configured to calculate rankings for members of the sporting competition based on the individual user ratings received. The rankings module is operable to generate rankings based on all ratings entered or a filtered set of ratings for a selected ranking group defined by one or more member and/or registered user tag elements indicative of characteristics of the members and/or registered users.

Preferably, the server comprises a display module that is configured to display the ratings received and/or calculated by the ratings module on the interface of the social networking system. The display module is operable to display the ratings numerically, graphically, or in any other suitable form. In one form, the display module is configured to generate a live rating graph for one or more members of the sporting competition based on the member's live average rating. For example, the display module is operable to generate a line-graph of a member's live average rating over time. The display module may be configured to update the line-graph periodically according to a predetermined time interval or in response to receiving an updated live average rating from the ratings module.

Preferably, social networking system comprises a transmission or communication module that is operable to send system data to and receive data from an external system. More preferably, the social networking system is operable to send system data to an external system periodically, continuously or upon request from the external system. In one form, the social networking system may be operable to send live ratings data associated with one or more members of the sporting competition to an external system associated with a television broadcaster for televising of the ratings data. In another form, the social networking system may be operable to send live ratings and/or rankings data for display on display screens located at the venue of a match being played in the sporting competition. The ratings and/or ranking data may be filtered such that only ratings and/or ranking data corresponding to members participating in the match at that venue are displayed.

In a third aspect, the present invention broadly consists in computer-readable medium having recorded thereon computer-readable instructions executable by a computer for carrying out the steps of:
providing a social networking system having an interface that is accessible by a plurality of registered users;
receiving individual user ratings on one or more members of the sporting competition from one or more registered users via the interface; and
calculating a live average rating for one or more members of the sporting competition based on the individual user ratings.

The computer-readable instructions of the computer-readable medium may comprise any one or more features mentioned in respect of the first and second aspects of the invention.

The phrase “sporting competition” as used in this specification and claims, unless the context suggests otherwise, is intended to mean any type of sporting competition ranging from a ‘multi-round’ sporting competition or sporting league comprising multiple teams or individual competitors and multiple rounds of matches between the individual teams or competitors over a season or competition period, including tournaments, to ‘single-event’ sporting competitions relating to a single match or game or sporting event between two teams or a group of individual competitors, whether held in the context of a multi-round sporting competition or a one-off sporting fixture, or any other form of sporting event or competition, whether teams-based or comprising individual participants.

The term “member” as used in this specification and claims, unless the context suggests otherwise, means any ratable member associated with a sporting competition, including individuals such as players, coaches, umpires, and teams or other ratable groups associated with a sporting competition, or any other party that may be rated based on their performance in the sporting competition.

The term “server” as used in this specification and claims, unless the context suggests otherwise, is intended to mean any one or more electronic machines, devices, computers, hardware, system, programmable electronic circuitry or the like, alone or in combination, which are configured to host or operate the social networking system, and/or any software or computer program running on such electronic systems to host the social networking system for access by one or more users.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

As used herein the term “and/or” means “and” or “or”, or both.

As used herein “(s)” following a noun means the plural and/or singular forms of the noun.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 shows a block diagram of the social networking system in accordance with an embodiment of the invention;

FIG. 2 shows diagram of an example timeline of a sporting competition format;

FIG. 3A shows a table of example match ratings data entered by registered users of the social networking system;

FIG. 3B shows a table of preseason predicted ratings data entered by registered users of the social networking system;

FIG. 4A shows a graph of preseason predicted rating, average season rating and average match rating for a member of the sporting competition based on ratings entered be registered users of the social networking system for a portion of the sporting competition;

FIG. 4B shows an example line-graph of a live average match rating ('live rating worm') for a player in a sporting competition over time;

FIG. 5 shows a screenshot of a home-webpage of an embodiment of the social networking system in the form of a website;

FIGS. 6A and 6B show screenshots of a user rating interface on a match webpage of an embodiment of the social networking system in the form of a website;

FIG. 7 shows a screenshot of a leaderboard webpage of an embodiment of the social networking system in the form of a website;

FIG. 8A shows a screenshot of a user profile webpage of a registered user of an embodiment of the social networking system in the form of a website;

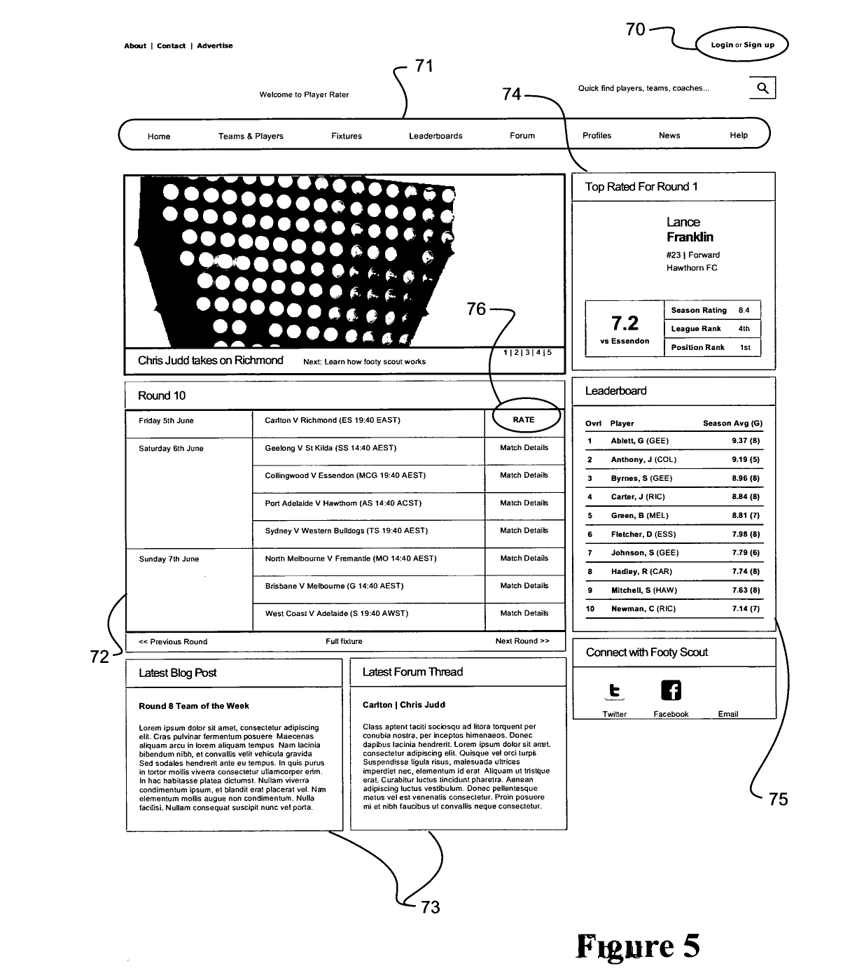

FIG. 5B shows a screenshot of a team profile webpage of a ratable member of the sporting competition, specifically a team, of an embodiment of the social networking system in the form of a website;

FIG. 5C shows a screenshot of a player profile webpage of a ratable member of the sporting competition, specifically a player, of an embodiment of the social networking system in the form of a website;

FIG. 9 shows a screenshot of a forum webpage of an embodiment of the social networking system in the form of a website;

FIG. 10 shows a screenshot of a blog webpage of an embodiment of the social networking system in the form of a website;

FIG. 11 shows a flow diagram of the typical system operation for a rating input by a registered user in accordance with an embodiment of the social networking system;

FIG. 12 shows a flow diagram of the flow of the ratings data input by a registered user in accordance with an embodiment of the social networking system;

FIG. 13 shows a flow diagram of the flow of comments input by a registered user in accordance with an embodiment of the social networking system; and

FIG. 14 shows a block diagram of the social networking system sending system data to an external system in accordance with an embodiment of the invention.

### DETAILED DESCRIPTION OF PREFERRED EMBODIMENTS

### Overview of Social Networking System

The present invention relates to a social networking system that provides users with a facility to rate and offer comments on the performance of professional athletes, coaches, teams and officials during a sporting competition. The social networking system may be applied to any particular sport or sporting competition, including, but not limited to: football (soccer, Australian rules and American football), basketball, cricket, baseball, rugby, boxing and hockey.

During a sporting competition, registered users may access the system and rate and comment on the performances of individuals and teams involved in the matches based on their opinion of how the individual and teams performed during the match. The system is arranged to store all ratings and comments made by a user and this historic data is displayed for view in various formats by other users on the system. The ratings provided by the users is also aggregated and averaged to generate an average public rating for the particular individuals and teams for display or output by the system. The system is configured to generate a live public average rating in that the public ratings are updated as soon as a user inputs a rating or changes a previous rating.

The ratings data input by the users is time-coded and stored so that various ratings data output may be calculated and displayed, whether in the form of a numerical, graphical or any other suitable representation. The ratings data collected from the users may also be used to calculate rankings for the various individuals and teams in the competition. The calculated rankings data may also be output for display by the system in various foinis for view by registered users or the wider public.

The social networking system may be implemented in the context of any type of sporting competition, whether a multi-round sporting competition, for example between multiple teams playing multiple matches over multiple rounds of a season, or a single-event sporting competition, for example a single sporting fixture between two teams or a group of individual competitors. The social networking system may be applied to either teams-based sporting competitions or events, or alternatively sporting competitions or events comprising individual competitors.

It will be appreciated that the social networking system may be implemented by an operator that is a third party to the sporting competition, the competition organisers or affiliates, or any of the competitors, whether teams or individuals. In some forms the social networking system may be operated by a third party or competition organiser to enable rating of all teams or individuals in the competition, but in other forms the system may be operated by or for individual teams or groups of individuals within a sporting competition, single-event or multi-round, for the rating of members in that or those teams or that group or groups of individuals. Therefore, the social networking system may be applied on a global or macro scale to all or many members (teams and/or individuals and/or officials) of a sporting competition, or on a micro scale to one or more smaller subsets of members of a sporting competition.

An embodiment of the social networking system will now be described in further detail, by way of example only and primarily in the context of a multi-round sporting competition between multiple teams. However, it will be appreciated that the various features and functionality of the social networking system may be applied or implemented in the context of a single-event sporting competition, such as a single match or game between two teams or group of individual competitors, whether or not in the larger context of an overall multi-round competition or sporting league, a one-off fixture, or otherwise.

### Social Networking System Website Embodiment

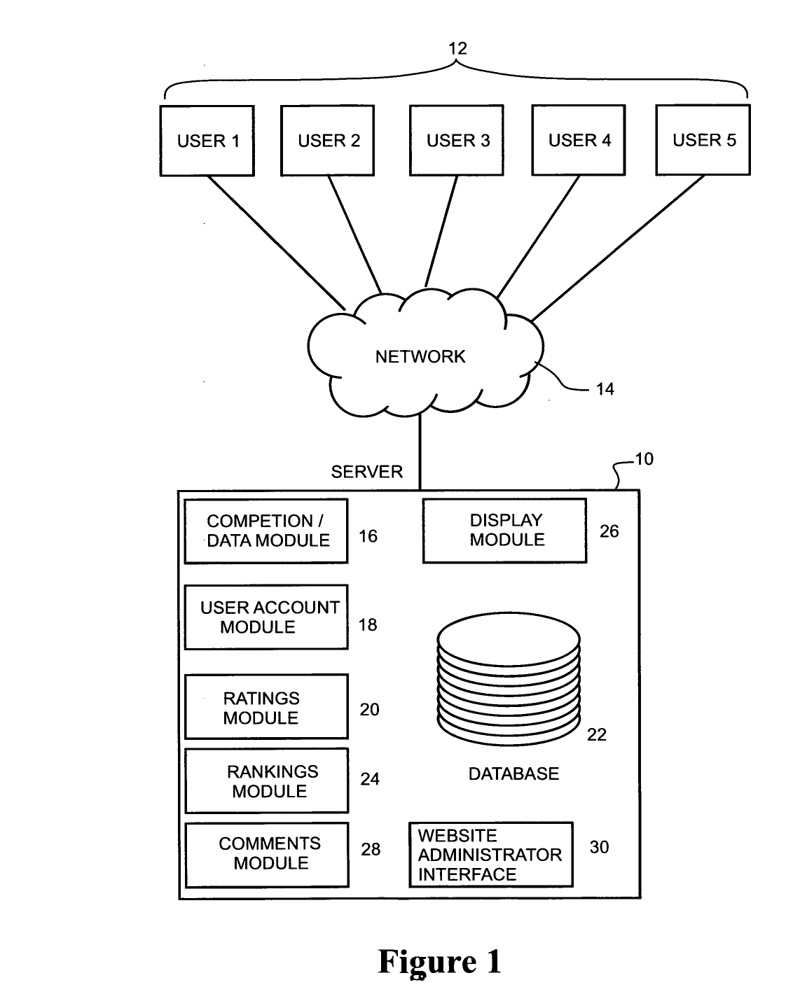

Referring to FIG. 1, the social networking system may be in the form of a website interface that is provided or hosted on a server 10 that can be accessed by one or more users 12 via a network 14, such as the internet. The users 12 may access the website via any suitable device, including a general purpose computer, whether desktop or laptop, or any other portable device having an internet browser capability, including, but not limited to, Portable Digital Assistance (PDAs), mobile phones, or any other device that is capable of accessing the network 14. The configuration, function and operation of the website interface is dictated by the server 10 which is programmed or configured to provide the website as will be appreciated to those skilled in website technology. For clarity of explanation, the server 10 configuration for running the website has been separated into modules that will each be explained in further detail as to their function and operation within the overall website. It will be appreciated that these modules share information and data with each other to carry out their particular function within the website. In alternative forms, the modules may be distributed on one or more servers or may be integrated with each other or further separated into additional modules as may be necessary.

### Competition Data Module

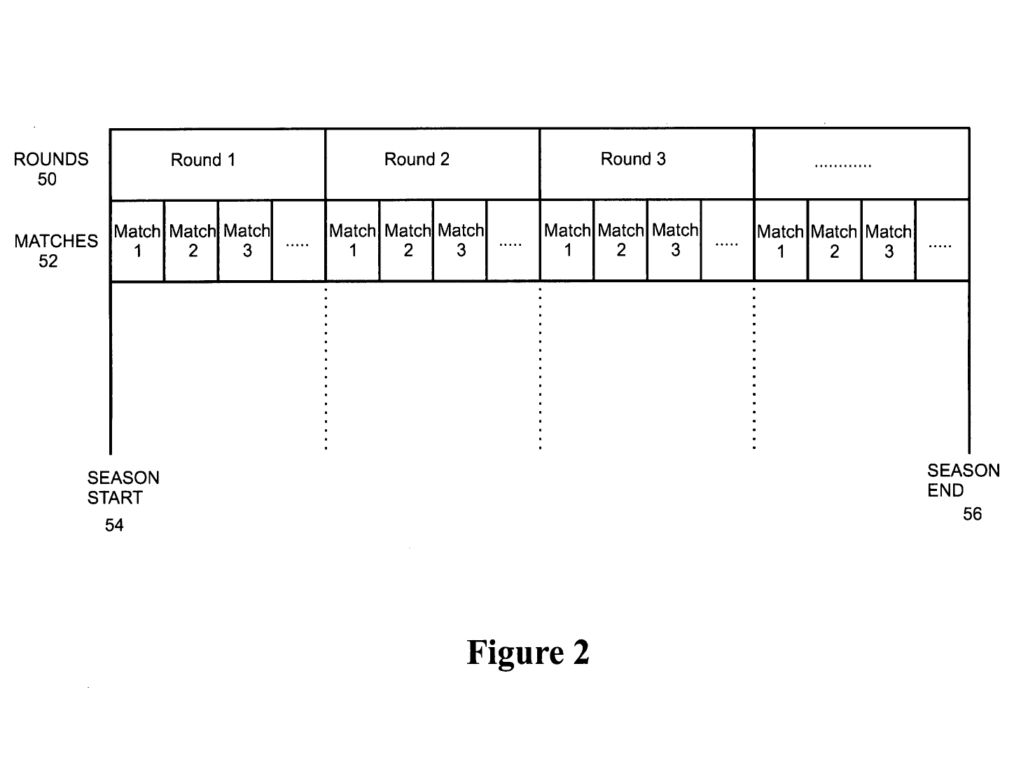

The competition data module 16 of the server 10 is arranged to receive and store competition data or information relating to the particular sporting competition associated with the website. In this embodiment, the website is customised for one particular sporting competition, although in alternative forms the website may be arranged or configured to support a plurality of different sporting competitions that are running concurrently or which overlap. The nature of the competition data stored by competition data module 16 depends on the structure of the particular sporting competition, whether a multi-round sporting competition or a single-event sporting competition. By way of example only and with reference to FIG. 2, the website configuration will be described with reference to a typical multi-round sporting competition that consists of a sporting season, having a start 54 and end 56, divided into multiple sequential rounds 50 played on a week-by-week basis. In each weekly round, each team plays an opposition team, with and their opposing team rotates each round. It will be appreciated that the social networking website could be adapted or configured for variations on this sporting competition format as desired, and could be adapted to suit any particular sporting competition or tournament format, or single-event sporting competition.

Before the start of the season 54, the server is loaded and configured with the competition data for the season. The competition data will vary depending on the type of sporting competition and format of the league, but will most often include match data comprising the round and match information, including dates, times and venues of the matches and teams playing, and any other match information, such as the officials or referees names. Alternatively, for a single-event sporting competition, the match data is indicative of the information for the single match between two teams. The competition data will also include member data on all ratable members associated with the sporting competition, whether individuals or teams. For example, the member data may comprise information on each of the teams in the competition and information on each of the individual players and coaches of the teams. The member data may also include information on the officials and referees in the sporting competition.

In this embodiment, server is loaded with individual member data for each ratable member of the sporting competition. Each individual member data will at least include information on the ratable member's name, whether a team name or the individual's (e.g. player, coach, or official) name, but optionally also one or more preset tag elements and one or more customised profile elements.

The preset tag elements define or are indicative of one or more characterises of the ratable member, and each tag element may be selected for a member from a predefined group of options. For example, each ratable member may have a type-tag element indicative of whether the member is a player, coach, official, or team. Further tag elements particular to each type of member may also be provided to further characterise the ratable member. For example, if the member is a player or coach, a team-tag element is provided indicating which team in the competition they are associated with. It will be appreciated that many tag elements particular to the various types of ratable members for further classifying or characterising them in a sporting competition context could be used as is deemed necessary and useful. By way of example only, players could be tagged with a position-tag element indicative of their on-field position (e.g. striker, midfielder, defender—in a soccer context). Other possible tag elements could relate to age, year drafted, career games played, salary or any other definable attribute or characteristic that can be used to group or categorise individual ratable members. As each individual ratable member has associated member data with one or more tag elements, the ratings and rankings data associated with members may be filtered according to one or more tag elements to generate useful leaderboards and comparison tables during the sporting completion as will be explained in further detail later.

As mentioned above, additionally, the member data associated with each ratable member in the competition may also have one or more customised profile elements. The customised profile elements may include any other desired information about the ratable member that cannot necessarily be categorised into options like with the preset tag elements. For example, the customised profile elements for individuals might include player history, individual milestones or the like. Team customised profile elements might include information on team history, championships won, supporter information or the like.

The competition data on the server may be updated as is necessary throughout the season. For example, teams may hire new players or fire a coach, or the officials for a particular match may be altered or match dates or times changed. The competition data is updated on the server to reflect the current status of the sporting competition throughout the season.

### User Account Module

In order to access the website interface to rate members of the sporting competition or to otherwise make comments and interact with the website and other users of the website, a user must register a user account with the server. Non-registered users will generally only be able to view ratings and rankings data displayed on the website webpages, but cannot otherwise interact with the website system without registering.

In this embodiment, the user account module 18 of the server provides a user registration interface on the website through which a new user may sign up as a registered user. It will be appreciated that any suitable form of website or account registration process could be used to provide access to the system, but preferably an online registration process is provided on the website as is common with most social networking websites. At the time of registration, the user is required to complete basic fields of information, which may include, by way of example only, name, username, and password. The information provided is stored for each registered user as user account data on the server. The user account data may also include one or more preset tag elements, which may assist in characterising the individual registered user. For example, at sign-up, each user may be required to select a team supported-tag element that is indicative of the team in the competition the user supports. Other tag elements may include gender, data of birth, residence, occupation, or the like. The user account data may also comprise one or more customised profile elements that include any other personal information that the user may wish to enter, such as background information or profile pictures.

### Ratings Module

Live Average Match Ratings The ratings module 20 provides a match rating interface through which registered users can input a rating against a ratable member, for example an individual player or team during each round of matches for a multi-round sporting competition. In this embodiment, the rating system is based on numerical ratings. By way of example only, registered users may enter an integer rating on a 1-10 rating index (1 representing the worse rating, 10 representing the best rating) against any member of the sporting competition during each round. It will be appreciated that any other scoring range or numerical rating scale could be used as desired.

During each round, the match rating interface allows users to enter or change their rating inputs for any particular member of the sporting competition at any point during a predetermined rating period associated with the round. Typically, the rating period for each round starts at the beginning of a round and ends at a predetermined time relative, generally prior, to the next round. For example, the end of the rating period may be 24 hours prior to the start of the next round of matches.

During a rating period for a particular round, users, via the match rating interface, can enter a rating on the scoring index against any one or more of the members of the competition, whether teams or individuals. Upon entering the rating, the rating data is time-coded as to when it was entered and stored against that individual user. The individual user's ratings may be entered or altered any number of times during the rating period of a round, including before the match, during the match, or post-match.

In a single-event sporting competition relating to a single match or game between two teams, one or more rating periods may be provided before, during and/or after the match. The configuration of the rating periods relative to the timeline of match may be varied to suit the type of sport being played. For example, there may be two rating periods per match, one for the first half and one for the second half, or alternatively four consecutive rating periods, each corresponding to a quarter of the match for example. The rating periods need not necessarily be continuous through the match, nor or uniform duration, although this may be desired for some types of sporting matches.

The ratings module 20 is arranged or configured to calculate a live average match rating for each member of the multi-round sporting competition during each round from the collective ratings received from all individual users that may have rated that member during the relevant rating period for the round. In particular, the ratings module 20 is configured to receive all ratings data for a member of the competition, aggregate that data and divide the total by the number of ratings to determine the live average match rating of the member of the sporting competition. In some forms of the system, the ratings module 20 is configured to generate a live average match rating for a member only once the number of ratings received from individual users exceeds a minimum calculation threshold. For example, a member may require at least five individual ratings before a live average match rating will be computed and maintained for that member, although it will be appreciated that the minimum calculation threshold may be altered as desired. For a single-event sporting competition, the live average match rating is calculated for the or each rating period provided for the sporting match. For example, a first-half live average match rating may be calculated for the first-half rating period and a second-half live average match rating for the second-half of the match.

In this embodiment, the ratings module 20 is configured to update the average match rating for each member of the competition on a live basis as soon as a new rating is entered or an existing rating is changed by a user for that member. Alternatively, in other forms, the ratings module may be configured to update the average match rating for each member of the sporting competition on a periodic basis throughout the relevant rating period (e.g. a round for a multi-round sporting competition or a first half of a single-event sporting competition) so as to take into account altered ratings data on a periodic basis rather than a strictly live basis, although this is less preferred depending on the frequency of the updates. High frequency updating may provide a suitable near live average rating for each member.

At the end of a ratings period for a round, the individual users are locked-out from altering their existing rating or entering new ratings against members in the sporting competition for that round. The final ratings entered by users are locked-in and stored by the server and the final average match rating for each member at the end of the rating period is then recorded against the member of the sporting competition for that round. The same applies for a ratings period within a single-event sporting competition. For example, a final first-half average match rating is stored at the end of the first half, and a final second-half average match rating is stored at the end of the second half.

### Season Average Ratings

In this embodiment, a running season average rating for each member of the multi-round sporting competition is also calculated by the ratings module 20 based on the round-by-round final average match ratings. For example, at the end of each rating period for a round, the final average match ratings for each member of the sporting competition is aggregated for all played rounds and divided by the number of played rounds to generate a running season average rating for the member.

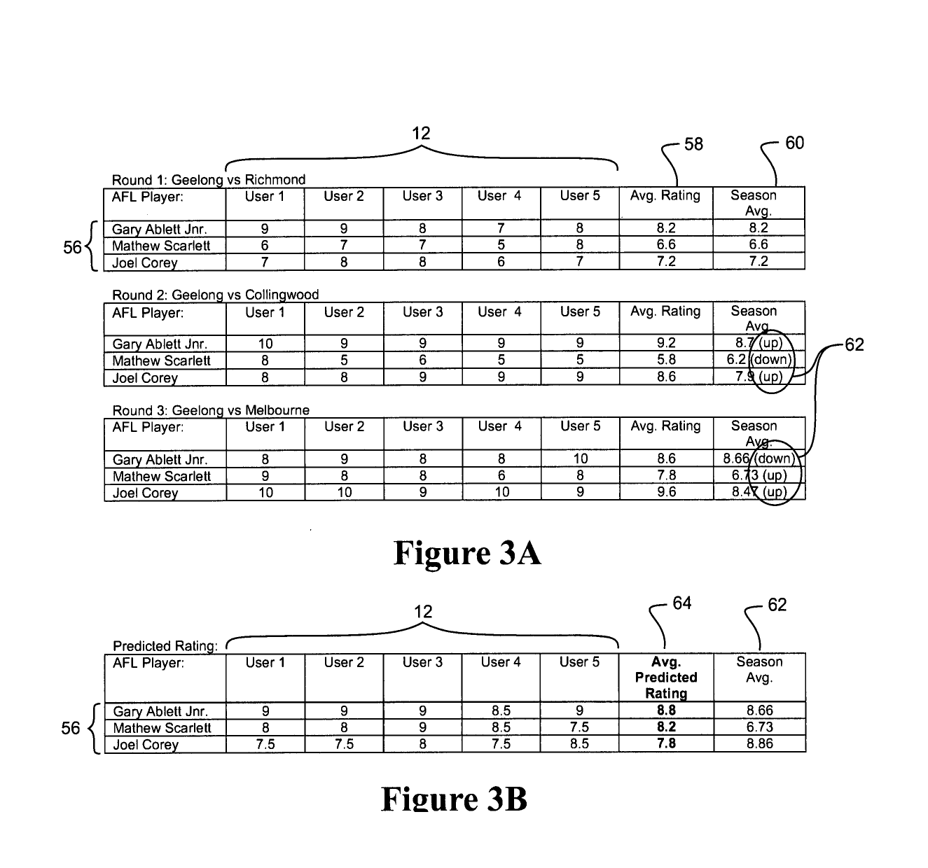

With reference to the tables in FIG. 3A, the ratings module will be explained in further detail with reference to example ratings data input from five users 12 in relation to three rounds of a competition. As shown, each of the users 12 has entered a rating on their opinion of the performance of three players in rows 56 of the table in each of the three rounds. The ratings shown in the tables of FIG. 3A are the final ratings locked-in at the end of the respective rating periods for each of the three rounds. The final average match rating for each of the players 56 is shown in column 58 in the tables as calculated by the ratings module 20 in the manner previously described. Additionally, the season average rating is shown in column 60 and which has also been calculated by the ratings module 20 in the manner previously described. For rounds two and three, the movement of the season average rating, if there is any, is also indicated relative to the previous season average of the previous round as seen at 62.

For a single-event sporting competition, the final average match ratings for the rating periods of the match (e.g. first-half and second-half, or first quarter-fourth quarter) are aggregated and averaged at the end of each rating period (half or quarter) to provide a running match average rating for the member.

### Preseason Predicted Ratings

In this embodiment, the ratings module 20 also includes a predicted rating system. The predicted rating system operates separately to the match rating interface and associated ratings calculations. The predicted rating system provides a predicted rating interface that allows users to enter a preseason predicted rating for any member of the multi-round sporting competition, whether individuals or teams, prior to the start 54 of the season or competition. The predicted rating interface may utilise the same or a comparable rating index or range as that employed match rating interface. In this embodiment, the predicted rating interface employs a 1-10 rating index, although a higher resolution of rating options or values are provided which are not limited to integers in the index. The predicted rating system is configured to permit predicted ratings input from users during a predicted rating period that exists prior to the start 54 of the season or competition. The length and position of the predicted rating period relative to the start of the season may be configured as desired.

Registered users may enter and alter their predicted ratings for any members of the sporting competition as many times as they wish during the predicted rating period, but once the period has expired, the predicted ratings are locked-in and stored against the individual users and the members of the competition. The individual users enter a predicted rating based on what they believe individual or team or other member of the sporting competition will have as a rating at the end of the season. By way of example, the table in FIG. 3B shows example predicted ratings input data from the five users 12 for the same three players 56 described with reference to FIG. 3A. As shown, the predicted rating system is configured to aggregate all predicted ratings input data for each player 56 and generate an average predicted rating as shown in column 64. As the season progresses, the season average rating in column 62 is updated by the ratings module as previously described round-by-round for comparison against the average predicted rating determined at the start of the season.

For a single-event sporting competition, a pre-game predicted rating may be entered by users for members of the sporting fixture in a predicted rating period prior to the start of the game based on what they believe the individual member of the match will have as a rating at the end of the game.

### Rankings Module

The rankings module 24 is arranged to receive and process the ratings data from the ratings module 20 in order to facilitate the calculation of rankings for the members of the sporting competition. The ratings data for the members of the sporting competition can be filtered by the rankings module in order to generate different ranking groups. Filtering of the ratings data to generate a ranking group may be based on characteristics of the ratable members, characteristics of the registered users, or both. The characteristics defining the ranking group may be based on one or more tag elements associated with the ratable members, registered users, or both. Some examples of ranking groups will now be explained by way of example only. The rankings module may be configured to generate rankings according to a predetermined set of ranking groups, in accordance with customised groups defined by users, or both.

### Member-Based Ranking Groups

The rankings module may be configured to filter the ratings data entered by users in accordance with one or more tag elements associated with the members of the sporting competition. For example, the ratings data could be filtered to cover only players for a particular team based on type-tag element (eg player) and team-tag element (eg Team A). Under this approach, all members of the sporting competition that are players in Team A may be ranked against each other according to any of their associated rating data. The rankings are preferably numerical rankings based on the size of the defined ranking group. For example, a ranking group having 20 members will be ranked from 1 to 20 based on the selected ratings data field. For example, the rankings may be performed based on any form of ratings data, including individual match ratings, live average match ratings, season average ratings, predicted ratings, or any other rating, whether in the context of a multi-round sporting competition or single-event sporting competition.

It will be appreciated that ranking groups based on any one or more tag elements could be configured to be calculated by the rankings module. Players of the same position in the competition could be ranked against each other, coaches could be ranked against each other, teams could be ranked against each other, and so on as desired.

### User-Based Ranking Groups

The rankings module may also filter ratings data based on characteristics of registered users. For example, ranking groups for registered users supporting the same team could be generated by the rankings module based on the ratings input of registered users having the same team supported-tag element. The ranking groups may also be further defined based on tag elements of members of the sporting competition. Under this type of configuration, users can generate ranking groups that show which supporter group is the most generous performance raters and also which supporter groups enter the highest ratings for players on the team they support.

Ranking groups can also be generated for the ratings data entered only by individual registered users. Such ranking groups enable registered users to view rankings based only on their own ratings input. For example, a registered user could configure the rankings module to generate a ranking group that shows that user's top rated players in any team, or for a particular position, and so on.

### Leaderboards and Tables

The ranking data generated by the rankings module 24 for any particular ranking group may be displayed in a leaderboard, table or any other suitable form. The rankings data can be updated on a live basis in accordance with any changes of live ratings data. The leaderboards enable presentation of the ranking data for analysis by registered users or the public generally, depending on where the leaderboards are displayed on the website interface.

### Display Module

The display module 26 is configured to control the content displayed on the website interface. The display module may be arranged to generate one or more webpages and present various graphical user interfaces (GUIs) that users may interact with to, for example, register as users, log in, update their profile information, enter ratings or view ratings data and rankings according to predetermined and user selected filters based on tag elements.

The display module is configured to utilise the ratings and ranking data to generate and display ratings and rankings. The display module also utilises the user account data and competition data in order to generate the content on the one or more webpages of the website interface

By way of example, the display module 26 is arranged to generate one or more leaderboards or tables that are arranged to display ordered ranking for desired ranking groups. The leaderboards may vary according to the associated ranking group to which they relate. The display module 26 may also be configured to generate any other form of display of the ratings or ranking data as grouped or filtered by any one or more tag elements, including graphical displays, table displays, or any other form of presentation of numerical information.

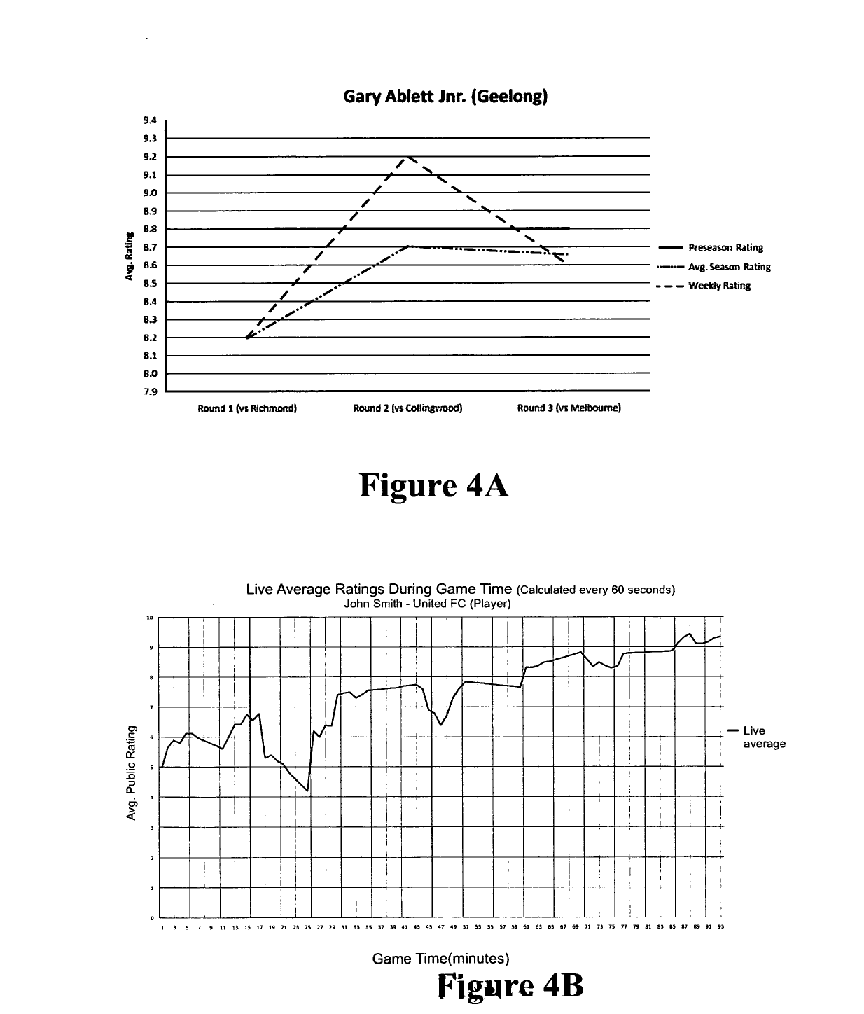

By way of example only, FIG. 4 shows a graphical representation of the preseason predicted rating, season average rating and average match rating for the ratings data of the first player shown in the tables of FIGS. 3A and 3B over the three rounds. It will be appreciated that the display module may generate any such graphical representations of the ratings data over time.

### Live Rating Graph

In an embodiment of the system, a live rating graph Clive rating worm') may be generated for any particular member of the sporting competition. The live rating worm is a graphical representation, for example a line-graph, of any member's average match rating plotted over the duration or a preselected time period within the rating period for any particular round (or rating period of a match for a single-event sporting competition). The live worm is updated continuously to match the live average match rating for the selected member of the competition as it changes based on new ratings input or as registered users alter their rating for that member during the rating period. In other forms, the live worm can be configured to update on a periodic basis wherein the frequency of updating can be varied to suit accuracy requirements desired. It will also be appreciated that multiple live worms for different members of the competition may be calculated and displayed concurrently, adjacent to each other or overlaying each other.

By way of example, FIG. 4B shows one possible graphical representation of the live rating worm for a player in the sporting competition. In this example, the live rating worm plots the player's live average match rating against the game time, represented in minutes from start to finish. In this example, the live average match rating for the player is calculated periodically according to a predetermined time interval, for example every 60 seconds, and the updated rating is plotted on the graph at the corresponding time in the game. As previously described, the live average match rating for the player at a particular time is calculated based on the average of all individual user ratings entered at that time, whether new entries or updated entries. Such periodic re-calculations of the live average match ratings are possible because all user ratings are time-coded or time-stamped as to when they were entered by the user.

### Member and User Profile Webpages

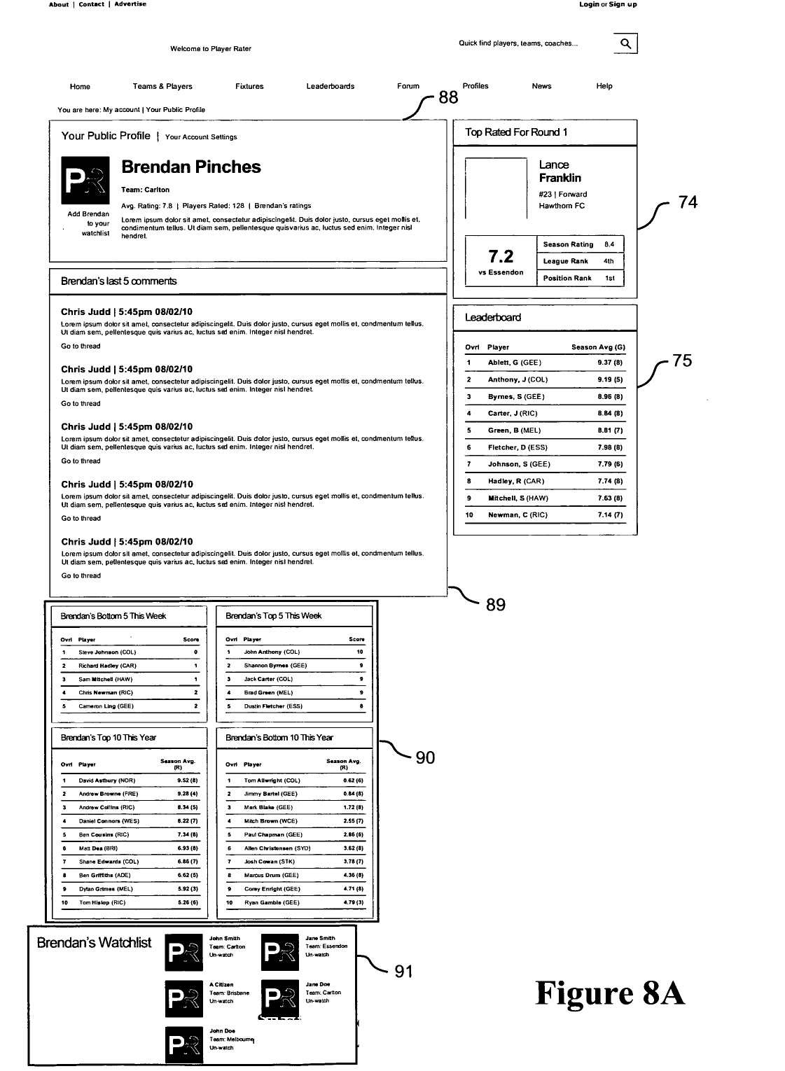

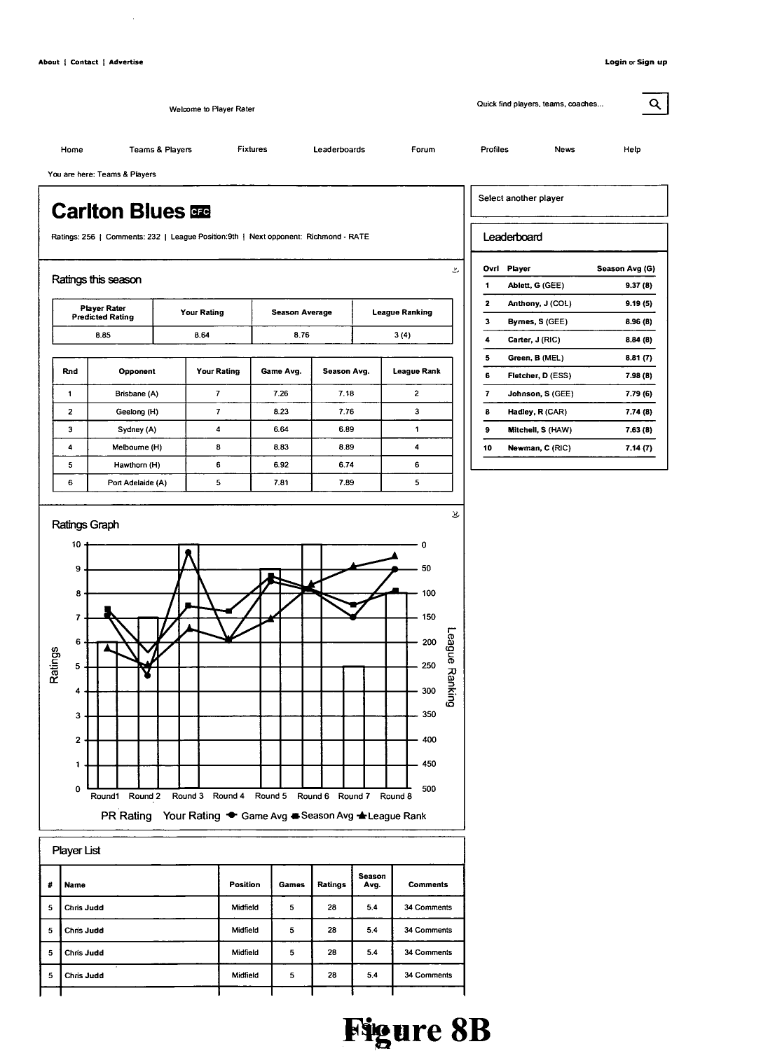

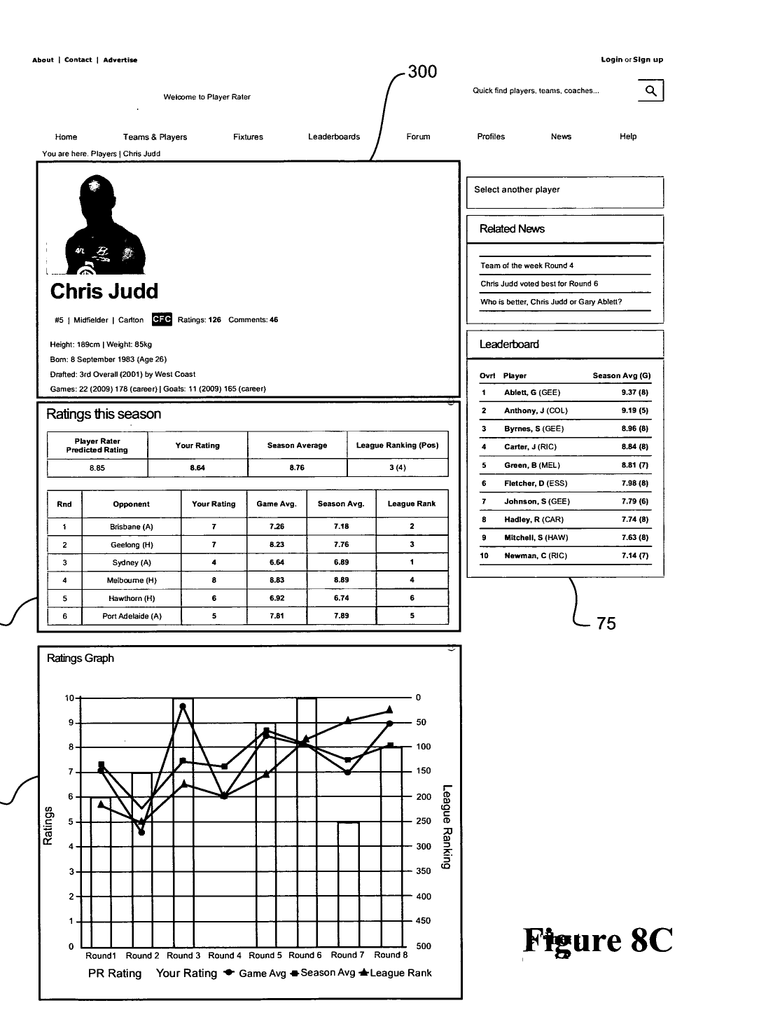

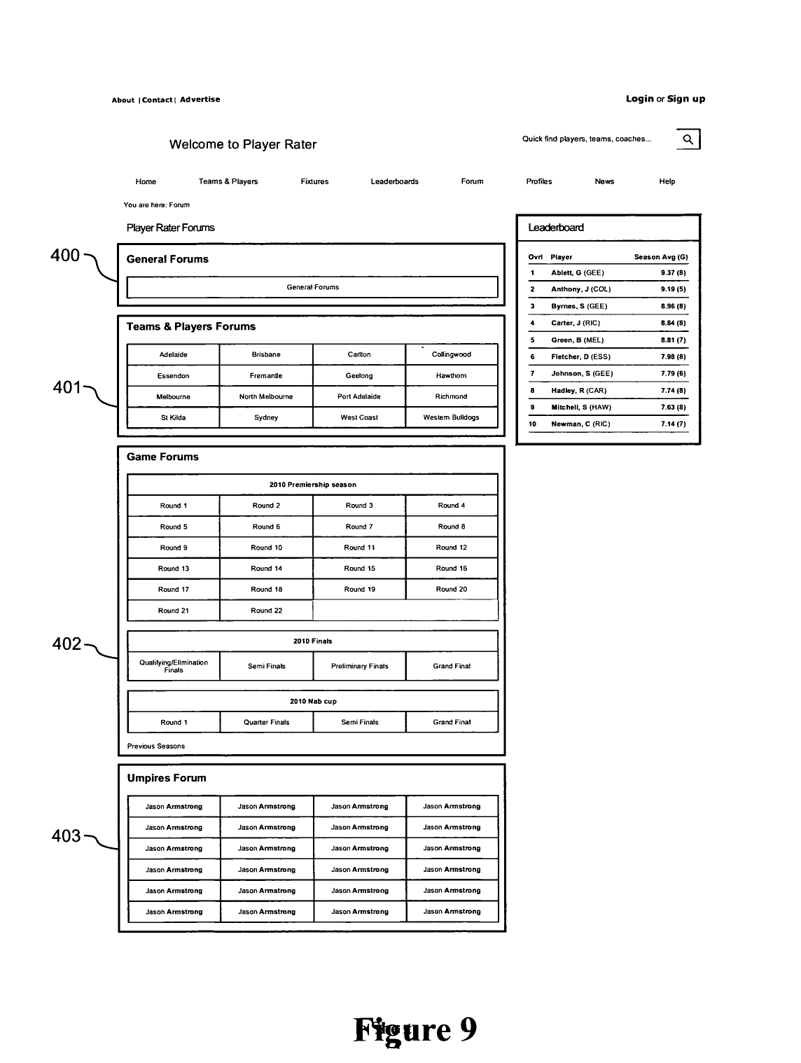

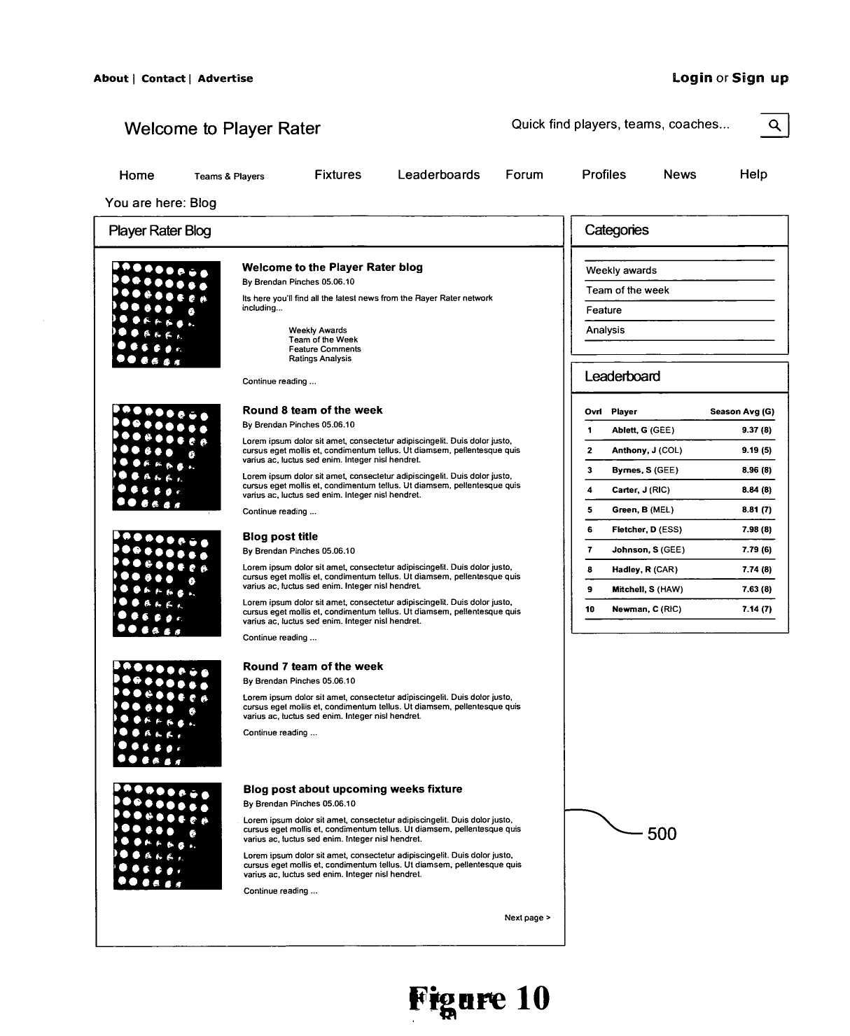

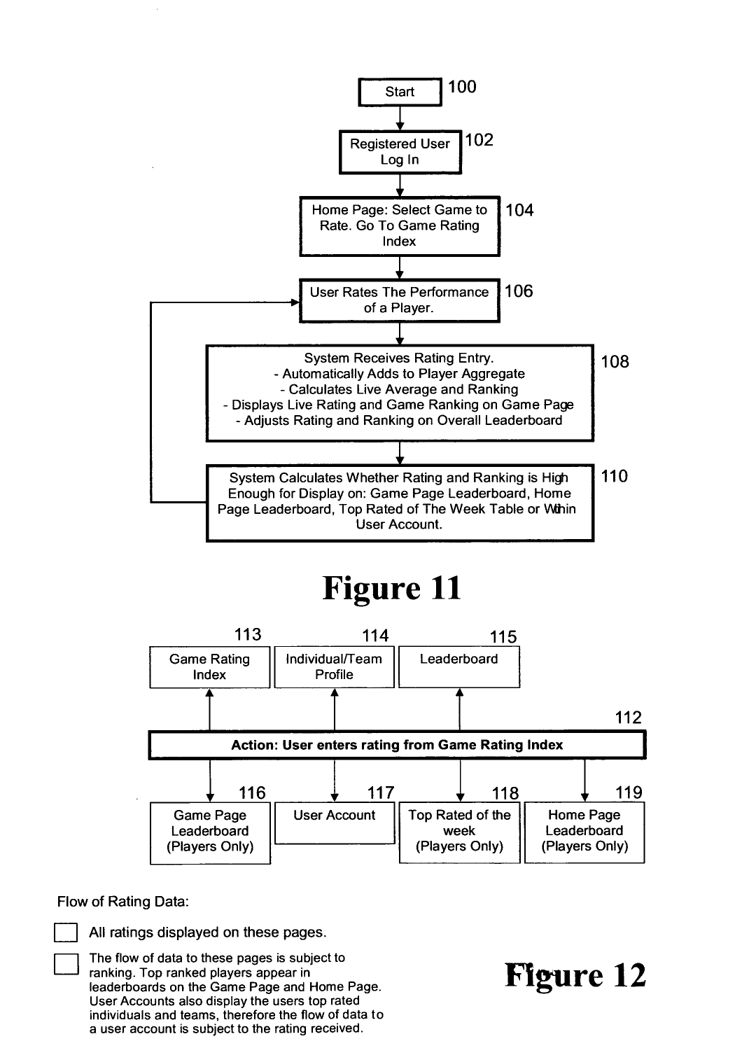

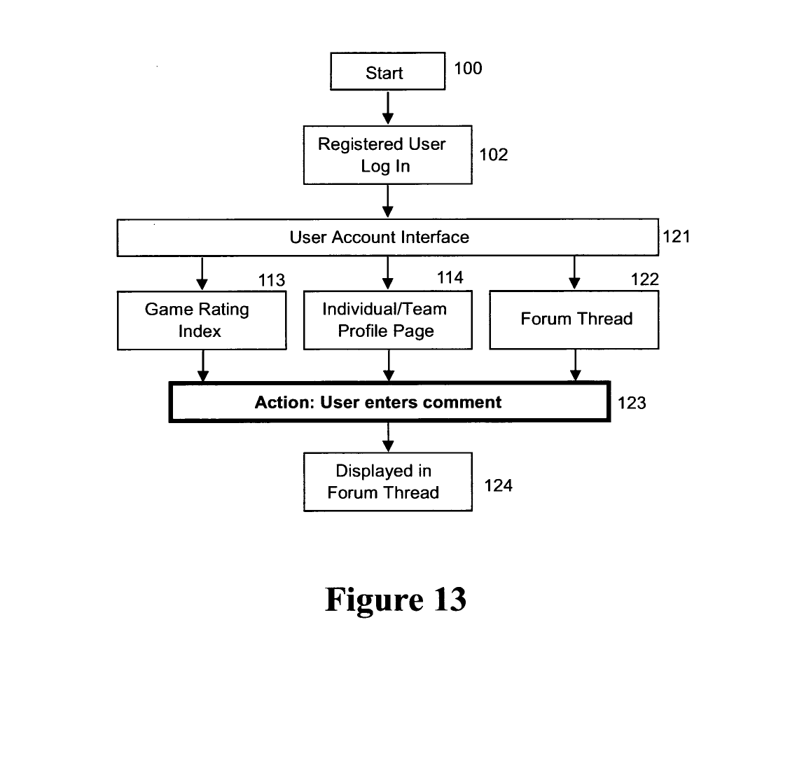

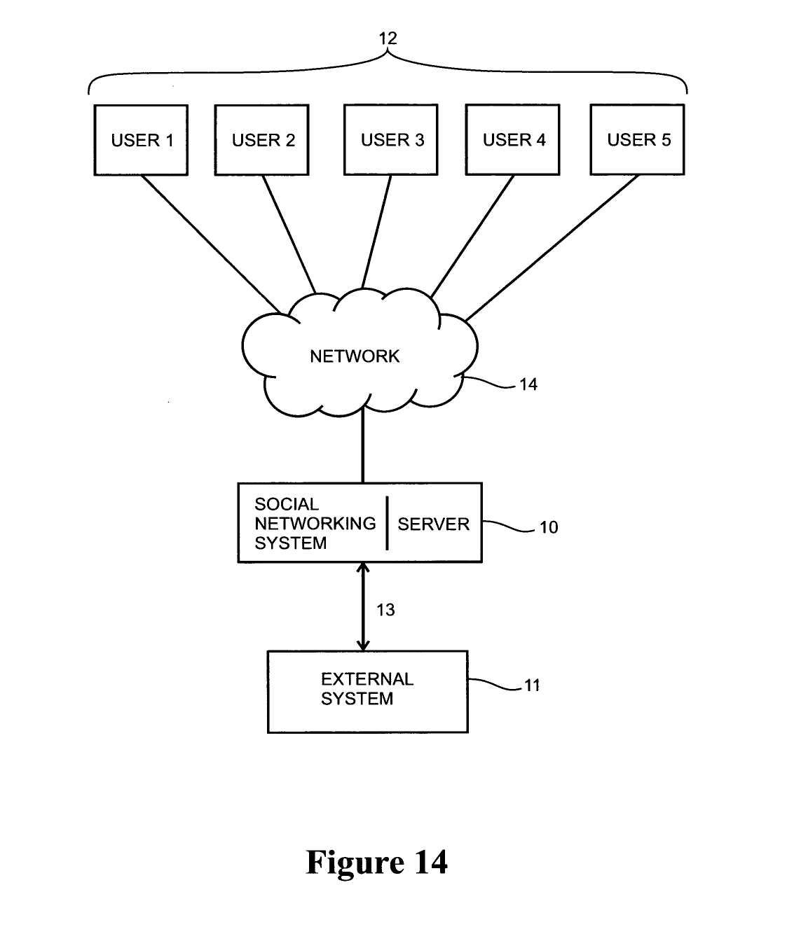

The display module 26 may also be configured to generate one or more profile webpages for each registered user and/or members of the sporting competition. In regard to the registered users, the information displayed on their individual user profile webpage can be selected according to their privacy settings, but minimum information will be displayed for each registered user in most embodiments. In regard to the members of the sporting competition, such as the players and teams, each member may have their own individual profile webpage. For example, each player may have a profile webpage detailing recent information on the player, and likewise the team would have its own profile webpage with information on the players, history of the team, championships won, and the like. The display module can also be arranged to retrieve and display ratings or ranking data or information for display in any suitable form on an associated profile webpage of a member of the sporting competition or a registered user. For example, each player profile webpage may display the player's average match rating and overall season ranking according to any ranking group as filtered by one or more desired tag elements. Likewise, the ratings entered by individual registered users may be displayed on their individual user profile webpages and the ratings data for each individual user may be filtered into ranking groups based on one or more tag elements as desired, and which has been previously described. Examples of various profile webpages are shown and described further with reference to FIGS. 8A-8C below.

### Comments Module

The comments module 28 is configured to receive and manage user comments and posts. For example, the comments module provides a comments interface on one or more of the webpages associated with the website through which registered users may enter a comment or post for display on one or more webpages. Each member of the sporting competition and registered user has an associated forum thread into which comments made about them, or by them, are logged and stored. When a comment is posted about any particular member of the sporting competition, for example via a comment interface on the member's profile webpage, the comment is received, stored and displayed in the member's associated forum thread. Each member's forum thread may be selectively displayed on the member's profile webpage. Registered user comments may also be logged against a registered user and displayed on the registered user's profile webpage. The various forum threads may be accessed through a common forum webpage or individual profile webpages or the like.

Blog articles may also be provided on a blog webpage within the website interface. Comments relating to the blog articles may also be entered by registered users for display in a blog forum thread.

The comments data is stored with the associated time the comment was entered and the display module 26 of the website may be configured to display comments on any of the webpages in time and date order. The comments module may be arranged to display comments that are entered within a particular predetermined time period, for example only displaying recently entered comments. Access to all comments may be provided by displaying the entire desired forum thread associated with a particular member or registered user.

### Database

The server may have one or more databases 22 or storage mediums in which the data for the system is stored for later retrieval and use by any of the modules. The data stored may include, but is not limited to, competition data, user account data, ratings data, ranking data, comments data and the like. Any form of electronic storage database may be employed. The one or more databases may be integrated or separate to the server.

### Website Administrator Interface

The server may provide a website administrator interface 30 which enables a website administrator to configure the system as desired. For example, the website administrator may access and alter content displayed on the webpages, the format of the webpages, including administration of the registered users and monitoring of the comments.

### Example Website Interface and Webpages

With reference to FIGS. 5-10, an example of a possible website interface, including various associated webpage layouts, in accordance with the embodiment of the social networking system described above will be explained by way of example only. The webpage layouts and configurations are shown by way of explanation of a possible implementation of the social networking system, and it will be appreciated that they could be adapted, altered and modified to suit different website designs and layouts. The data and information provided in the various webpages is provided for explanatory purposes only.

### Home Webpage

FIG. 5 shows a home webpage. The home webpage may include a link 70 to enable registered users to log in or for new users to sign up as previously explained in accordance with the user account module. Links or page tabs 71 to other main webpages on the website are provided. In this embodiment, the home webpage is arranged to display details of the matches occurring in the current round of the sporting competition as shown at 72. Blog posts or forum thread information may also be displayed on the homepage as shown at 73. Particular ratings data, for example, top rated members of the sporting competition and their member details may be displayed on the homepage at 74. One or more leaderboards may also be displayed as shown at 75. Registered users may access the match rating interface to make their ratings by various links on the home webpage, including, for example rate link 76 associated with a match of the round.

### Match Rating Interface Webpage

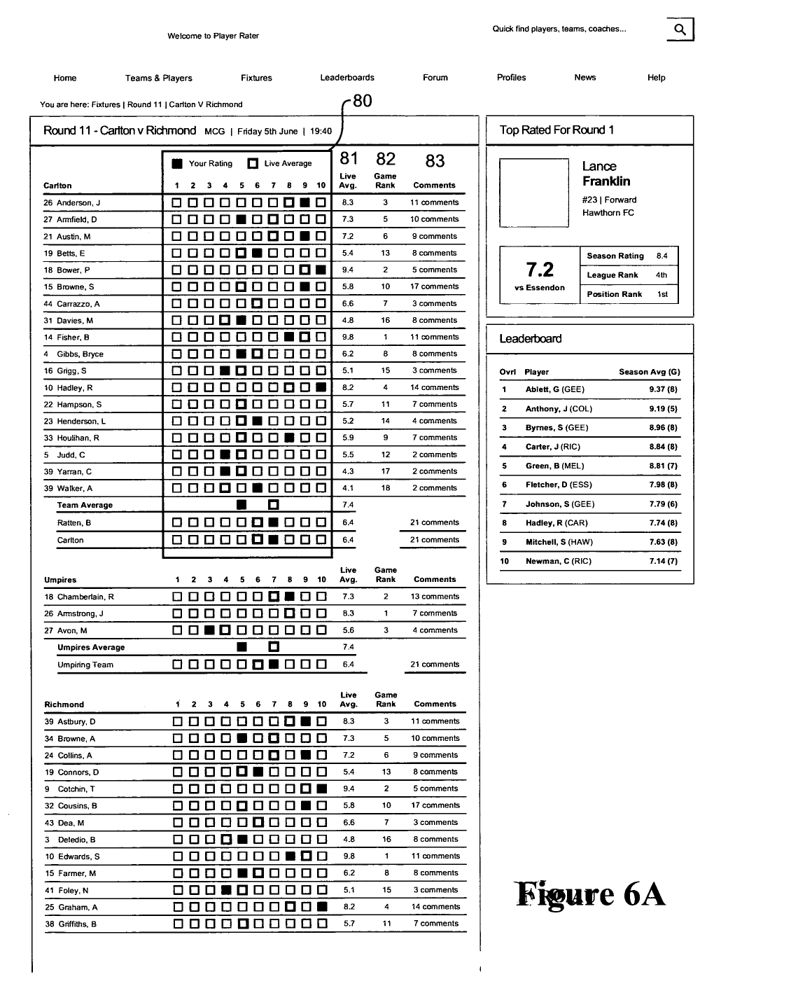

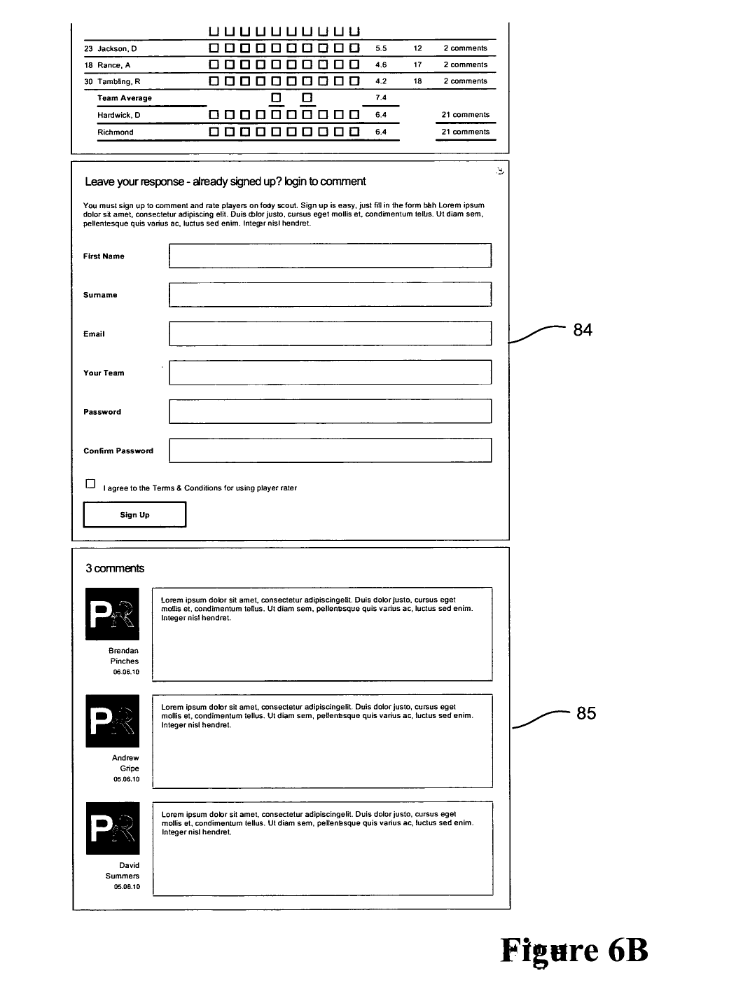

FIGS. 6A and 6B show a possible match rating interface webpage for a particular match. As shown, all members relating to the match, including players of both teams and the umpires are displayed. Each member is provided with a 1-10 rating index through which the user may select their rating as shown at 80 by clicking the graphic user interface (GUI) on their selected rating value for the or each member they wish to rate. The user's rating input is received and processed by the ratings module as soon as the user enters the rating via the GUI.

The rating index 80 displays the user's selected rating, as entered, and the live average match rating to the nearest integer. The live average match rating is also displayed next to each rating index as shown at 81 for each member as determined by the ratings module 20. The live average match ratings may be displayed to any desired level of accuracy, but in this case this data is shown to one decimal place. A ranking may also be provided for each member as calculated by the rankings module. In this example, a game ranking is provided for all players relative to their teammates, i.e. ranking groups are formed based on the team-tag element such that the ratings data for the members of each team are filtered and ordered to generate a numerical ranking for the player within the team. As shown at 83, the number of comments or posts about a particular member of the sporting competition may be displayed and links through to the associated forum thread of each member are provided. Referring to FIG. 6B, a comments interface for entering comments is shown at 84 and various comments displayed in relation to the match are shown at 85.

### Leaderboards Webpage

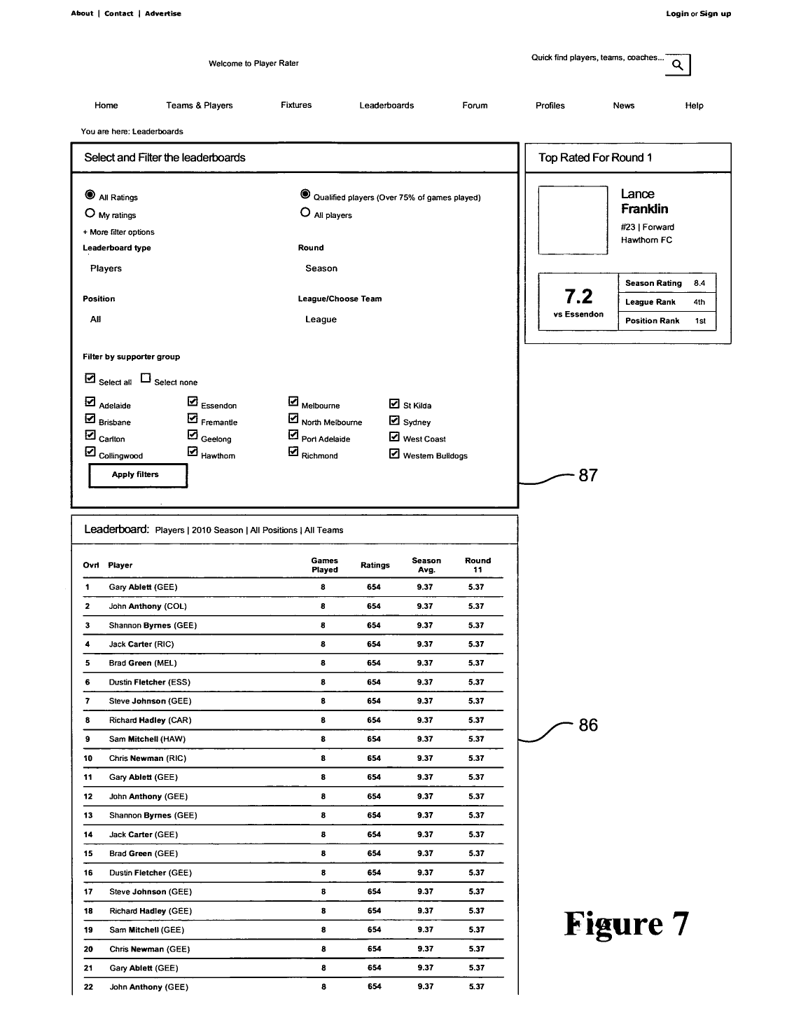

Referring to FIG. 7, an example of a leaderboard displaying ratings and rankings is shown at 86. As previously described, user selected leaderboards may be displayed which filter ratings data according to one or more user and/or member tag elements as shown at 87. This enables the users to display leaderboards containing ratings data for a desired ranking group that can be categorised by one or more common tag elements.

### User Profile Webpage

FIG. 8A shows an example of a profile webpage for an individual registered user. The user's webpage may include predetermined information on the registered user as shown at 88, which they entered during registration, including possibly any customised profile elements. Comments or posts by the individual user may also be displayed as shown at 89 from their associated forum thread. One or more leaderboards displaying various ranking groups of ratings data entered by the individual user can also be displayed as shown at 90. Links to other registered user profile webpages, as stored in a watchlist created by the individual user, may also be displayed as shown at 91. This provides individual registered users with quick links to access the profile webpages and ratings entered by other registered users. As is known in social networking websites generally, the website interface may provide a facility for searching for other registered users to form links between registered users. Various other main leaderboards 75 or profiles for top rated members 74 from the home webpage may be reproduced on each user's profile webpage. A comments interface and the user's forum thread may also be displayed on the profile webpage, similar to those shown at 84 and 85 in FIG. 6B.

### Member—Team Profile Webpage

FIG. 8B shows an example of a profile webpage for a ratable team in the sporting competition. Along with team information, one or more ratings and rankings summary tables may be displayed as shown at 200. Such summary tables may present the various ratings associated with the team, including current and historical ratings data round-by-round. The summary tables may also be configured to display user rating data representing the ratings entered against that team by the individual user accessing the webpage such that the team profile webpage is partially customised for each registered user's ratings data, along with the average ratings data from all registered users. As shown at 201, one or more graphical representations of the team's historical ratings data over the sporting competition, for example round by round, can be plotted and displayed. The graphed ratings data may include any one or more of the predicted rating, average match ratings, season average rating, rankings data, and individual ratings data specific to the registered user accessing the profile page. Team information, such as player lists, may be displayed as shown at 202, with links provided to each individual player's profile webpage. Again, a main leaderboard 75 may be displayed, and comments interfaces and forum threads associated with the individual team may be provided.

### Member—Player Profile Webpage

FIG. 8C shows an example of a profile webpage for a ratable player in the sporting competition. The layout and content of the player profile webpage may be very similar to the team profile webpages, although this is not essential. For example, summary profile information, including a profile picture, about the player may be provided as shown at 300. Like with the team profile webpage, a summary table 301 and graphical representation 302 of ratings and ranking data specific to the player and customised to include the rating data entered by the registered user accessing the profile webpage is may be displayed. A comments interface and forum thread associated with the player may also be provided, along with main leaderboards 75.

### Forum Thread Webpage

FIG. 9 shows an example of a main forum thread webpage providing an interface for selecting and accessing forum threads associated with different categories of ratable members and users. Users may traverse and search through these categories and then link to individual forum threads for any desired individual members of the sporting competition or registered users to make comments or to simply view the comments in the thread. Example categories of forum threads may include general forum 400, teams and players forum 401, game forum 402, and umpires forum 403. Through each of these categories, users may access the specific ratable member or game forum they desire.

### Blog Webpage

FIG. 10 shows an example of a blog webpage within which articles may be posted, for example by individual registered users or authorised users, or the website administrator. Users may access the various blog articles 500 to read and then optionally post comments or replies to other comments or posts by other registered users of the system.

### Example Website Operations by Registered Users

With reference to FIGS. 11-13, examples of typical operations by registered users of the website of this embodiment will be explained, along with the flow of data in the system as a result of the user's interaction with the website. The operations are provided by way of explanation only and can be varied in other forms of the system.

### Ratings Input by Registered Users

Referring to FIG. 11, a registered user may start 100 by firstly logging in to the system at step 102. The user is then linked to the home webpage at step 104. The user may then select a match or game to rate and link to the associated match rating interface as shown on FIG. 6A. As previously described, at step 106 the user may enter their rating against any one or more members associated with the selected match, or alter an existing rating. The rating module 20 receives any new or altered rating entry at step 108. Upon receipt of the new rating for a member (or an altered rating), the ratings module adds the rating to the aggregate (or alters the aggregate) for that member and then proceeds to calculate the live match average and update any associated rankings data, for example the member's game ranking. The updated live average match rating and game ranking are then displayed on the game webpage and the ratings data and ranking data filtered throughout the remainder of the webpage that utilises that member rating data and new rankings calculations are made, if necessary for the leaderboards or other tables. All leaderboards, including ratings and rankings data are updated in accordance with the new rating entry input. At step 110, the display module 26 is configured to calculate whether the member's new rating and ranking data is within predetermined thresholds for displaying on various leaderboards and webpages, including the game webpage leaderboard, home webpage leaderboard, top rated of the week table or within a registered user's own leaderboards, for example as shown at 90 in FIG. 8B.

### Flow of Rating Data in the System

Referring to FIG. 12, the flow of ratings data upon the input of a rating or alteration of a rating by a registered user will be explained. When the user enters or alters a rating at 112 in a manner previously described, the individual registered user's rating is used to update the live match average rating as previously described and this flows back to the match ratings interface 113 and which is shown by way of example in FIG. 6A, the rated member's profile webpage 114, and the leaderboards 115. If the new ratings data input 112 causes a rated member's live average match rating to enter a top ranking leaderboard, that data may flow through to webpages displaying top ranking leaderboards, such as on, for example, the game webpage leaderboard 116, the registered user's leaderboards 117 and as shown at 90 in FIG. 8B, the top rated of the week 118 and as shown at 74 in FIG. 5, and the home webpage leaderboard 119 and as shown at 75 in FIG. 5.

### Comments or Posts by Registered Users

Referring to FIG. 13, a registered user may enter a comment by logging in as previously described 120. Via the user account interface 121, the user may then access the match rating interface 113, member profile webpage 114 or individual forum thread 122 via the forum thread webpage as shown for example in FIG. 9. The user may then enter their comment or post at 123, for example via a comments interface as shown by way of example at 84 in FIG. 6B. The user's comment or post is then displayed in the forum thread associated with the member upon which the comment was associated with at 124. The comments data is also stored in that member's forum thread.

System Communication with External Systems or Networks

Referring to FIG. 14, the system data received, generated and/or stored by the social networking system 10, including for example the ratings data and rankings data, may be transmitted or sent to any other external network, device or system 11. For example, the ratings and/or rankings data may be transmitted on a continuous or periodic basis by a transmission module of the social networking system 10 to one or more external or remote systems 11. The social networking system 10 and external system 11 may communicate over any suitable communication medium or link, whether wired, wireless or a combination of these, and using any suitable communication protocol. The two systems may communicate directly or indirectly, for example via a network, such as the internet or private network. The data transmitted may be packaged or streamed in any suitable form and upon receipt by the external system 11 may then be processed, stored and/or displayed by that receiving network or system 11 as desired.

### Television Networks and Broadcasting

By way of example, in one possible embodiment the ratings and ranking data received and stored by the social networking system may be transmitted to an external system of a media or broadcasting outlet to display alongside their live match broadcasts. The broadcaster or media outlet receiving the data may also then display it on their websites or other associated forums. In one particular example, the live ratings data for one or more members associated with a match may be displayed or televised concurrently with the live match being played in the sporting competition. For example, the live rating worm previously described may be shown or displayed for one or more members (e.g. players, teams, or umpires) involved in the match as the match is broadcast live for television watchers. In this form, the system operates to generate public ratings data for use by third parties.

### Display at Venue

In another possible embodiment, the ratings and ranking data received and stored by the social networking system may be transmitted to sports venue operators where it may be displayed on screens at the venue for the crowd during a match in the multi-round sporting competition or for a single-event sporting competition. The ratings and rankings data may be filtered to correspond to members of the sporting competition (e.g. players) corresponding to the match that is actually being played at the venue.

### Implementations of the Social Networking System

By way of example, the social networking system has been described in the form of a website or website interface accessible via the internet via user internet browsers. It will be appreciated that the website may be programmed in any suitable software or coding language. In alternative fain's, access to the system need not necessarily be provided by a website accessible via an internet browser, but rather an interface in the form of a custom application program may be loaded onto each individual user's computer, whether desktop, laptop, tablet, or any other hardware device, such as a mobile phone, smart phone, Personal Digital Assistant or the like, through which they may access the server or system. Such a customised application program may be loaded and run on any suitable electronic device of the user's choosing that has network access capability or connectivity to enable the application program to interact with the server interface and exchange data in accordance with system operations, whether over a network such as the internet, a cellular network, or any other communications network or medium. It will be appreciated that the implementation of the system may be in any other electronic form, whether computer implemented or otherwise implemented by one or more programmable devices or systems.

In one alternative embodiment, each user interface for the social networking system is provided in the form of a dedicated application program for a user's mobile phone or smart phone, or any other suitable portable communications device or electronic device having data communications capability. By way of example, to access the social networking system the users may download the mobile application program to their phone and load the software to provide access. The application program provides the user with the same interactive functionality and content as the website interface previously explained above in the form of application program GUIs. The social networking system operates in much the same way except data between the user and server is exchanged by an application program rather than via a website interface on an internet browser.

The social networking system and method may also be embodied in software, for example a computer-readable medium having stored thereon computer-readable instructions for execution by a computer for performing the systems operations, configuration and method steps previously described. The computer-readable medium may be in any suitable form, including but not limited to, CD-ROM, DVD, memory device, or any other electronic or file data storage medium.

### Public or Private Social Network Embodiments

The embodiment described previously relates to the social networking system in the form of a website for wider public use in relation typically to national or otherwise high-profile sporting competitions. The social networking system may also be configured for private use by smaller sections or groups of the public. For example, a social networking system may be configured for use by sporting clubs or smaller sporting organisations so that these clubs and organisations can implement and administer their own social network system for their sporting competitions to allow a forum for rating of members of their sporting competitions.

### Software Package—Private Social Networking System

In one form, the social networking system may be provided to a sporting club or organisation as a software package comprising configuration files and data files enabling the club or organisation to set up their own private social networking system website customised for their particular sporting competition. The software package may be in the form of computer readable medium having recorded thereon instructions for configuring the system and operating the system on a private server of the club or organisation. The software package may provide a configuration or set-up interface, and administration interface or other content management system to enable the club or organisation to enter the competition data for their particular sporting competition, including teams, players and the like in a manner similar to that previously described. Users having access to the system on the private server may then register and enter ratings on members as previously described. The private server of the organisation or club may be accessed over the interne or other private network as desired by the purchaser. Otherwise, the social networking system configuration and operation is similar to that described previously.

### Content Management System—Host Public Social Networking System

In another form, a public social networking system may be provided with a content management system or configuration portal which sporting clubs or other organisations may use under subscription. The content management system provides an interface through which subscriber clubs or organisations may add their sporting competition to an established public social networking system run on a third party server. With this arrangement, the public social networking system may be configured to act as a host for receiving ratings on multiple sporting competitions. The content of each sporting competition, including the member and competition data, may be managed by the respective subscriber club or organisation via the content management system. Users may register to make ratings on any one or more of the sporting competitions hosted on the social networking system, although it will be appreciated that subscribers may restrict access to particular users for their particular sporting competition if they wish. Under this arrangement, clubs or organisations wishing to establish a rating system for their sporting competition may piggy-back on the host public social networking system run by a third party without having to incur the expense of running their own separate social networking system on their own private server.

### Summary of Benefits and Advantages

In some forms, the social networking system may offer the following advantages and benefits. The social networking system provides a forum through which the public may express their opinions in the form of a rating on the performances of athletes in sporting competitions. The system stores ratings data and provides a mechanism through which historical ratings data of users is stored and can be assessed by other users. The ability to access historical ratings data or other personal information about users in the system allows users to better gauge the opinion and values of other users, which enriches communication and the exchange of opinions. The system provides a facility where opinion in the form of ratings can be delivered in a common, quantifiable and comparable language by the wider public.

The foregoing description of the invention includes preferred forms thereof. Modifications may be made thereto without departing from the scope of the invention as defined by the accompanying claims.

1.-46. (canceled)

47. A method of facilitating the live rating of members of a live sporting competition, comprising:
providing a server that is accessible by a plurality of users via respective user interfaces connected to the server over a network;
receiving individual user ratings on one or more members of the live sporting competition from one or more users via their respective user interfaces;
calculating a live average rating for one or more members of the live sporting competition based on the individual user ratings; and
displaying the live average rating of one or more members of the live sporting competition on one or more displays during the live sporting competition.

48. A method according to claim 47 wherein at least one user interface is a website interface accessible by an internet browser program and which is configured to communicate with the server over the internet.

49. A method according to claim 47 wherein at least one user interface is an application program running on a portable hardware device comprising a communication module for accessing the network to communicate with the server.

50. A method according to claim 49 wherein the portable hardware device is selected from any of the following: smartphone, mobile phone, tablet computer, notebook computer, laptop computer, and Personal Digital Assistant.

51. A method according to claim 47 wherein the step of receiving individual user ratings comprises receiving numerical ratings on a rating index.

52. A method according to claim 47 wherein the step of receiving individual user ratings comprises receiving ratings during rating periods associated with the timeline of the sporting competition, and wherein the step of calculating a live average rating comprises calculating a live average rating for each member of the sporting competition during each rating period based on all the collective individual user ratings received for each respective member during that rating period.

53. A method according to claim 52 wherein the live average rating for a member is re-calculated each time a new individual user rating is received for that member.

54. A method according to claim 52 wherein the live average rating for each member is re-calculated periodically.

55. A method according to claim 47 wherein the method further comprises the step of receiving predicted ratings on one or more members of the sporting competition from one or more users prior to the commencement of the sporting competition.

56. A method according to claim 47 wherein the method further comprises the step of calculating rankings for members of the sporting competition based on the individual user ratings received and displaying the rankings of one or more members of the live sporting competition on one or more displays.

57. A method according to claim 56 wherein the step of calculating rankings comprises calculating rankings for members of a ranking group, wherein the ranking group is defined by one or more selectable tag elements that are indicative of one or more common characteristics of the members of that group.

58. A method according to claim 47 wherein the step of displaying the live average rating of one or more members comprises displaying the live average rating of one or more members on the display(s) in graphical form.

59. A method according to claim 47 wherein the live sporting competition is a single-event sporting competition and wherein the step of displaying the live average rating of one or more members comprises televising the live average rating of one or more of the members for television viewers such that the live average rating(s) are displayed concurrently with the live television broadcast of the sporting competition.

60. A method according to claim 47 wherein the live sporting competition is a single-event sporting competition and wherein the step of displaying the live average rating of one or more members comprises displaying the live average rating of one or more of the members on one or more display screens located at the venue of the live sporting competition.

61. A system for facilitating the live rating of members of a live sporting competition, comprising:
a server configured to operate the system, the server being accessible by a plurality of users via respective user interfaces connected to the server over a network;
a ratings module operating on the server that is configured to: receive individual user ratings on one or more members of the live sporting competition from one or more users via their respective user interfaces; and calculate a live average rating for one or more members of the sporting competition based on the individual user ratings;
a database associated with the server for storing ratings data indicative of the live average rating for one or more members of the sporting competition; and
a display module operating on the server that is configured to display the live average rating of one or more members of the live sporting competition on one or more displays during the live sporting competition.

62. A system according to claim 61 wherein at least one user interface is a website interface that is accessible by an internet browser program and which is configured to communicated with the server over the internet.

63. A system according to claim 61 wherein at least one user interface is an application program running on a portable hardware device comprising a communication module for accessing the network to communicate with the server.

64. A system according to claim 63 wherein the portable hardware device is selected from any of the following: smartphone, mobile phone, tablet computer, notebook computer, laptop computer, and Personal Digital Assistant.

65. A system according to claim 61 wherein each user interface comprises a ratings interface that is operable by a user to enter their individual ratings on one or more members of the sporting competition, and wherein the ratings interface is configured to provide a selectable numerical rating on a rating index.

66. A system according to claim 61 wherein the ratings module is configured to receive individual user ratings during rating periods associated with the timeline of the sporting competition, and wherein the ratings module is configured to calculate a live average rating for each member of the sporting competition during each rating period based on all the collective individual user ratings received for each respective member during that rating period.

67. A system according to claim 66 wherein the ratings module is configured to re-calculate the live average rating of a member upon receiving a new individual user rating for that member.

68. A system according to claim 66 wherein the ratings module is configured to re-calculate the live average rating for each member periodically.

69. A system according to claim 61 wherein the server comprises a rankings module that is configured to calculate rankings for members of the sporting competition based on the individual user ratings received and wherein the display module is configured to display the rankings of one or more members of the live sporting competition on one or more displays.

70. A system according to claim 61 wherein the display module is configured to generate a live rating graph for one or more members of the sporting competition based on the member's live average rating and wherein the display module is further configured to display the live rating graph on the display(s).

71. A system according to claim 61 wherein the live sporting competition is a single-event sporting competition and the server comprises a transmission module for transmitting ratings data to an external system, and wherein the display module is configured to transmit ratings data to an external system that is configured to televise the ratings data of one or more members of the sporting competition for television viewers such that the live average rating(s) are displayed concurrently with the live television broadcast of the sporting competition.

72. A system according to claim 61 wherein the live sporting competition is a single-event sporting competition and the display module is configured to display the live average rating of one or more of the members of the sporting competition on one or more display screens located at the venue of the live sporting competition.

73. A system according to claim 61 wherein the ratings module comprises a predicated ratings system that is configured to receive predicted ratings on one or more members of the sporting competition from one or more users prior to the commencement of the sporting competition.
